(19) United States
(12) Patent Application Publication
(10) Pub. No.: US 2026/0300752 A1
(43) Pub. Date: Oct. 1, 2026

(54) TRAINING NEURAL NETWORKS ON SESSION DATA

(71) Applicant: Google LLC, Mountain View, CA (US)

(72) Inventors: Inderjit Singh Dhillon, Berkeley, CA (US); Babu Rao Kashyap Kolipaka, Iselin, NJ (US); Lan Nie, Fremont, CA (US); Max Moroz, Sunnyvale, CA (US); Samer Hassan Hassan, Saratoga, CA (US); Sundeep Tirumalareddy, San Francisco, CA (US); Hui Li, Palo Alto, CA (US); Xingyu Wang, Sunnyvale, CA (US); Zhenshuai Ding, San Jose, CA (US)

(21) Appl. No.: 19/489,090

(22) PCT Filed: Oct. 10, 2024
(86) PCT No.: PCT/US2024/050719

§ 371 Date: Dec. 1, 2025

Related U.S. Application Data
(60) Provisional application No. 63/590,247, filed on Oct. 13, 2023.

(51) Int. Cl. G06N 3/096; G06F 16/953

(52) U.S. Cl. CPC G06N 3/096; G06F 16/953

(57) ABSTRACT

Methods, systems, and apparatus, including computer programs encoded on computer storage media, for training a neural network using training data generated from user session data are described. In one aspect, a method includes obtaining session data that describes a user sessions. Each user session represents a corresponding interaction between a user and a search engine that occurs during a period of time. A training sequence is generated from the session data. For each user session, the training sequence includes subsequence blocks arranged one after another in a predetermined order. A neural network is trained, including learning parameter values of the neural network, by using the training sequences.

### CROSS-REFERENCE TO RELATED APPLICATIONS

This application claims the benefit under 35 U.S.C. § 119 (e) of U.S. Patent Application No. 63/590,247, filed Oct. 13, 2023. The foregoing application is incorporated herein by reference in its entirety for all purposes.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains a neural network using a two-stage process. During the first stage (which can be referred to as a “pre-training” stage), the system trains a neural network using multiple training sequences generated from session data. During the second stage (which can be referred to as a “fine-tuning” stage), the system adapts the pre-trained neural network using task-specific training data to perform any of a variety of downstream machine learning tasks.

In general, one innovative aspect of the subject matter described in this specification can be embodied in methods that include the actions of obtaining session data that describes multiple user sessions, each user session representing a corresponding interaction between a user and a search engine that occurs during a period of time; generating, from the session data, a training sequence for each of the user sessions, the training sequence including multiple subsequence blocks arranged one after another in a predetermined order, each subsequence block including (i) a search query subsequence that represents a search query submitted by the user to the search engine, (ii) a search result subsequence that represents one or more resources identified by the search engine based on the search query, and (iii) a user action subsequence that represents one or more actions performed by the user in response to the one or more identified resources; and training a neural network including learning parameter values of the neural network by using the training sequences based on optimizing a pre-training objective function. Other implementations of this aspect include corresponding apparatus, systems, and computer programs, configured to perform the aspects of the methods, encoded on computer storage devices.

These and other embodiments can each optionally include one or more of the following features. Some aspects include fine-tuning the neural network for a given task using one-shot learning or few-shot learning.

In some aspects, each subsequence includes a respective text token at each of multiple input positions selected from a predetermined vocabulary of text tokens. In some aspects, the training sequence includes a metadata subsequence that represents metadata associated with the user session. The metadata associated with the user session can include a geographic location of the user.

In some aspects, the search query subsequence includes a timestamp indicating when the search query was received by the search engine from the user. In some aspects, the search result subsequence includes, for each identified resource, one or more of a resource address of the identified resource, a title of the identified resource, or a brief description of the identified resource.

In some aspects, the one or more actions performed by the user includes a selection of one of the identified resources, a browse of one of the identified resources, or both by the user. In some aspects, the predetermined order is a temporal order in which the search queries represented by the subsequence blocks were received by search engine from the user.

In some aspects, training the neural network by using the training sequences based on optimizing the pre-training objective function includes, for each of one or more of the training sequences, processing, using the neural network, one or more subsequence blocks that precede a particular subsequence block of the training sequence to generate a predicted search query subsequence that is a prediction of a search query subsequence included in the particular subsequence block and determining, based on a difference between the predicted search query subsequence and the search query subsequence included in the particular subsequence block, an update to the parameter values of the neural network.

In some aspects, training the neural network by using the training sequences based on optimizing the pre-training objective function includes, for each of one or more of the training sequences processing, using the neural network, the search query subsequences included in a particular subsequence block of the training sequence to generate a predicted search result subsequence that is a prediction of a search result subsequence included in the particular subsequence block and determining, based on a difference between the predicted search result subsequence and the search result subsequence included in the particular subsequence block, an update to the parameter values of the neural network.

In some aspects, training the neural network by using the training sequences based on optimizing the pre-training objective function includes, for each of one or more of the training sequences, processing, using the neural network, a search query subsequence and a search result subsequence included in a particular subsequence block of the training sequence to generate a predicted user action subsequence that is a prediction of a user action subsequence included in the particular subsequence block and determining, based on a difference between the predicted user action subsequence and the user action subsequence included in the particular subsequence block, an update to the parameter values of the neural network.

In some aspects, generating the training sequence for each of the user sessions includes replacing one or more text tokens included in the training sequence with mask tokens in accordance with a predetermined mask probability. Some aspects include, after the training, adapting the trained neural network to perform a downstream task, wherein the downstream task includes one of: a resource relevance estimation task, a next search query prediction task, or a resource identification task.

In some aspects, training the neural network by using the training sequences based on optimizing the pre-training objective function includes training a teacher neural network by using the training sequences; generating truncated training sequences that exclude the search query subsequences included in the training sequences; and using the trained neural network to train the neural network based on knowledge distillation by using the truncated training sequences. In some aspects, the neural network is an attention neural network that includes multiple attention blocks.

In some aspects, generating the training sequence for each of the user sessions includes removing user identifying information from the session data.

In some aspects, generating the training sequence for each of the user sessions includes identifying a search query that has been received from fewer than a threshold number of users and removing, from the training sequence, each subsequence block that includes the search query.

In some aspects, generating the training sequence for each of the user sessions includes identifying a search result that has been provided to fewer than a threshold number of users and removing, from the training sequence, each subsequence block that includes the search result.

In some aspects, generating the session data for each of the user sessions includes limiting each subsequence block to a portion of the user session.

In some aspects, generating the training sequence for each of the user sessions includes limiting the training sequence for each user session to a threshold number of subsequence blocks.

In general, one innovative aspect of the subject matter described in this specification can be embodied in methods that include the actions of obtaining session data that describes multiple user sessions, each user session representing a corresponding interaction between a user and a content system that occurs during a period of time; generating, from the session data, a training sequence for each of the user sessions, the training sequence including multiple subsequence blocks arranged one after another in a predetermined order, each subsequence block including (i) an initial user action subsequence that represents a first user interaction with the content system, (ii) a content response subsequence that represents one or more responses provided by the content system, and (iii) a subsequent user action subsequence that represents one or more subsequent actions performed by the user in response to the one or more responses; and training a neural network including learning parameter values of the neural network by using the plurality of training sequences based on optimizing a pre-training objective function. This aspect can include one or more of the aspects described above and elsewhere herein.

The subject matter described in this specification can be implemented in particular embodiments so as to realize one or more of the following advantages. The described techniques can generate training sequences from session data that was obtained and/or generated as a result of user interactions with a search system, e.g., an Internet search engine, and/or other resources of a content system (e.g., web pages, digital components, videos, etc.) and train a neural network using the training sequences. By applying the training sequences as training data during the pre-training of the neural network, the system improves the reasoning capabilities of the neural network and facilitates the learning of knowledge about complex problem solving and task accomplishment through the use of various resources in many real-world settings by the neural network.

As a result of the pre-training, the neural network can be more easily adapted, e.g., through one-shot learning, few-shot learning, or other fine-tuning techniques, to any of a range of downstream tasks. For example, the neural network can be adapted to predict a user's intent for the purposes of selecting search results in response to a query, to provide a digital component in response to a query or digital component request, and/or recommend other types of content (e.g., images, videos, etc.) of a content system. Once adapted, the neural network can achieve or even exceed the accuracy of a conventionally pre-trained neural network on any of the downstream tasks, despite an adaptation process that consumes fewer computing resources, is faster in terms of wall-clock time, or both. Thus, the neural network can be trained faster and using fewer resources, while still providing enhanced performance relative to other training processes. In some implementations, the session data is converted from its raw format into a format that is similar to language model pre-training data and the language model is trained on the formatted session data. In this way, the pre-trained language model can be adapted to the one or more downstream task more quickly and with reduced computational resource consumption because it can more practically leverage what it has learned from the pre-training.

In addition, the adapted neural network can be smaller and/or less complex than the pre-trained model, enabling the neural network to be used in real time to respond to requests for content, e.g., to provide search results in response to queries, to provide digital components in response to queries or component requests, and/or to recommend web pages, videos, or other resources based on user interactions with a resource (e.g., a web page, video platform, etc.). In such situations, content may need to be provided in milliseconds to avoid page load errors and/or user frustration that would otherwise occur if content is not provided in the short amount of time. Thus, the adapted neural network can reduce such errors and user frustration, while providing accurate outputs.

The system that trains the neural networks can take one or more steps to protect the security of user data used to train the neural networks and to preserve user privacy. In some implementations, the system trains the neural networks using subsequence blocks that represent a constrained set of interactions rather than longer sessions. In this way, identifiers, such as user identifiers or session identifiers that link multiple subsequence blocks are not used in the training or even stored by the system. This prevents user activity across multiple resources (e.g., across multiple websites or domains) from being stored or accessible if the system is breached. For example, each subsequence block may be limited to one resource or one query such that multiple resources and/or queries cannot be correlated for any user. Thus, training using subsequence blocks rather than entire sessions enhances user privacy and can be used with other privacy enhancement techniques described herein, e.g., with k-anonymity techniques, to further enhance user privacy and data security.

When session data that includes multiple subsequence blocks of a user session or multiple user sessions of a user are used to train a neural network, the subsequence blocks for a user session or multiple user sessions can be linked using an anonymous identifier that has no relation to the user or even to the sessions themselves. For example, the system can assign a random, pseudo-random, or other identifier to subsequence blocks that are part of a same session or multiple sessions of a common user. This also prevents user activity across multiple resources from being linked to an actual user if the system is breached.

The system can also evaluate the data included in each subsequence block to identify any data that can be used to identify a user or is specific to a particular user before training a neural network using the subsequence data. For example, the system can remove any user identifiers, credit card numbers, contact information (e.g., phone numbers, physical addresses, e-mail addresses, etc.), and/or other personal information. The system can also employ k-anonymity techniques to ensure that data that may not otherwise be sensitive cannot be linked to a particular user. For example, if at least a threshold number of users have not viewed a digital component, the data related to views and interactions with this digital component may not be used to train a neural network.

The system can also be configured to adapt to changes that restrict the use of particular types of data to train neural networks. For example, if data related to interactions with digital components are restricted from use, the system can delete this data and retrain or update the neural network such that this data is no longer part of the neural network.

In sum, the described techniques train and use machine learning models, e.g., neural networks, using subsequences of user sessions to perform specific tasks more efficiently and accurately while protecting the privacy of user data used to train the models. The two-stage straining process using subsequences and privacy enhancements provides a particular way of training models to achieve these benefits and can be applied to particular technological fields, such as Internet searches, content recommendation, etc.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, postal code, or state level), so that a particular location of a user cannot be determined. Thus, the user may have control over what information is collected about the user, how that information is used, and what information is provided to the user.

The details of one or more embodiments of the subject matter of this specification are set forth in the accompanying drawings and the description below. Other features, aspects, and advantages of the subject matter will become apparent from the description, the drawings, and the claims.

### BRIEF DESRIPTION OF THE DRAWINGS

FIG. 1 shows an example training system.

FIG. 2 illustrates an example environment that includes a search engine.

FIG. 3 illustrates an example process for training a neural network using multiple training sequences.

FIG. 4 illustrates a flow diagram of sub-steps of one of the steps of the process of FIG. 3.

FIG. 5 illustrates another flow diagram of sub-steps of one of the steps of the process of FIG. 3.

FIG. 6 illustrates yet another flow diagram of sub-steps of one of the steps of the process of FIG. 3.

FIG. 7 illustrates an example process for using a trained neural network to perform a machine learning task on an input to generate an output.

FIG. 8 shows a block diagram of an example computer.

Like reference numbers and designations in the various drawings indicate like elements.

### DETAILED DESCRIPTION

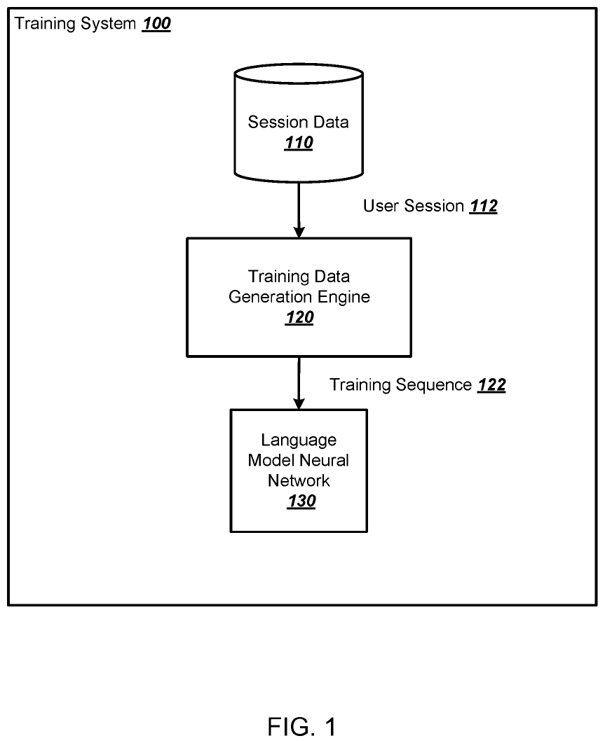

FIG. 1 shows an example training system 100. The training system 100 is an example of a system implemented as computer programs on one or more computers in one or more locations, in which the systems, components, and techniques described below can be implemented.

The training system 100 includes a language model neural network 130, but can include other types of neural networks as well. The language model neural network 130 can be any appropriate language model neural network that receives an input sequence made up of text tokens selected from a vocabulary and auto-regressively generates an output sequence made up of text tokens from the vocabulary. For example, the language model neural network 130 can be a Transformer-based language model neural network or a recurrent neural network-based language model.

In some situations, the language model neural network 130 can be referred to as an auto-regressive neural network when the neural network used to implement the language model neural network 130 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the language model neural network 130 can process the current input sequence to generate a score distribution, e.g., a probability distribution, that assigns a respective score, e.g., a respective probability, to each token in the vocabulary of tokens. The language model neural network 130 can then select, as the particular token, a token from the vocabulary using the score distribution. For example, the language model neural network 130 can greedily select the highest-scoring token or can sample, e.g., using nucleus sampling or another sampling technique, a token from the distribution.

As a particular example, the language model neural network 130 can be an auto-regressive Transformer-based neural network that includes (i) a plurality of attention blocks that each apply a self-attention operation and (ii) an output subnetwork that processes an output of the last attention block to generate the score distribution.

The language model neural network 130 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

A Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this particular example, the output subnetwork processes the output hidden state generated by the last attention block in the sequence for the last input token in the input sequence to generate the score distribution.

Generally, the training system 100 is a system that obtains training data and uses the training data to train the language model neural network 130 to perform one or more machine learning tasks, e.g., to determine trained values of the parameters of the language model neural network 130 and outputs data specifying a trained language model neural network 130, e.g., data that includes at least the trained values of the parameters.

The language model neural network 130 can be configured through training to perform any kind of machine learning task. Some examples of machine learning tasks that the language model neural network 130 can be trained to perform follow.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, e.g., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task can be a natural language processing, inference, or understanding task that operates on a sequence of text in some natural language to generate an output. Example natural language processing, inference, or understanding tasks include an entailment task, a paraphrase task, a textual similarity task, a sentiment task, a sentence completion task, a grammaticality task, a commonsense task, a closed-book question answering task, a reading comprehension task, a reading comprehension with commonsense task, a coreference resolution task, and the like.

As another example, the task can be a text generation task, where the input is a sequence of text, and the output is another sequence of text, e.g., a completion of the input sequence of text, a response to a question posed in the input sequence, a sequence of text that is about a topic specified by the first sequence of text, or a summary of the input sequence. In the last example, the machine learning task may also be referred to as a summarization task, which aims at generating, from a corpus of text, a more condensed text description that encapsulates the most important information from the corpus of text.

As another example, the task can be to generate an intent of a user based on an input that indicates one or more user interactions of the user. For example, the input can be a text sequence that indicates a type of user interaction and a resource (e.g., web page, video, image, digital component, etc.) with which the user interacted. The input can include a sequence of interactions, e.g., interactions that occur over the course of a user session (e.g., a user session with a search system, a website, or a chatbot) and/or contextual data related to the interactions (e.g., time, geographic location, content presented to the user during the session, etc.). The intent can then be used to select content to provide to the user. For example, the content can include search results (e.g., if the user interaction includes one or more queries), a digital component, an image, a video, and/or other content. As another example, the task can be to select the content based on the input, e.g., directly without first predicting the intent of the user.

In some cases, the machine learning task is a combination of multiple individual machine learning tasks, e.g., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

The training data includes session data 110. The session data 110 can be generated as a result of user interaction(s) with one or more resources. As described in further detail below, the resources can include a search engine, web pages, content platforms (e.g., image and/or video sharing platforms), chatbots, digital assistants (e.g., smart speakers), and/or other types of resources. The interactions can include user interactions with content presented by the resources, e.g., with digital components presented by the resources. Interactions can include, for example, views of a resource, selections (e.g., clicks) of the resource, selections of content of a resource (e.g., digital component, link to another resource, etc.), downloads of content from a resource, providing data (e.g., a query or image) to the resource, and/or other types of user interactions.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

The session data 110 includes contextual data of user sessions. As described below, the contextual data can be related to an environment in which the user session occurs. The session data 110 can, for example, be received by the training system 100 from another system, e.g., an external system that is in data communication with the training system 100, that implements a search engine which provides search services to users. Example types of contextual data are described below.

The training system 100 can perform one or more actions to protect user session data such that the data cannot be associated with a particular user. For example, the training system 100 can evaluate the data to identify any data that can be linked to a particular user and/or that identifies the user. For example, the training system 100 can use a set of rules (e.g., pattern matching rules) to identify any user identifiers, contact information (e.g., addresses or phone numbers), credit card numbers, etc. and remove any identified data.

The training system 100 can also employ k-anonymity techniques to ensure that data that may not otherwise be sensitive cannot be linked to a particular user. For example, if at least a threshold number of users have not viewed a digital component, the data related to views and interactions with this digital component may not be used to train a neural network. Instead, the training system 100 can store the data until at least a threshold number of users have performed the action with respect to the resource or item and then use the data to train a neural network after the threshold is satisfied. Similarly, if at least a threshold number of users have not submitted a search query, viewed a search result, or viewed another resource (e.g., web page, video, image, etc.), the data related to these items may not be used to train the neural network.

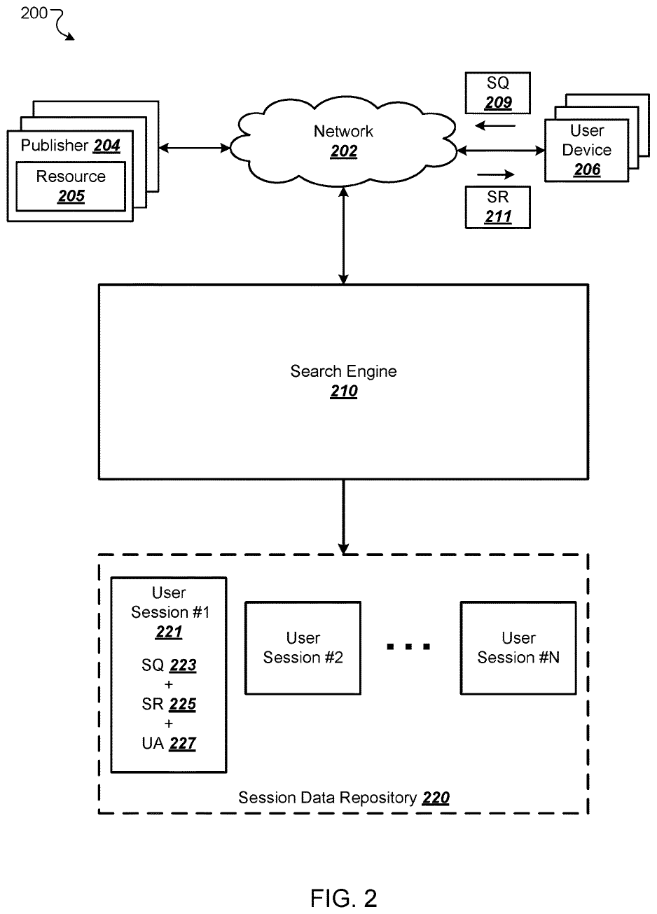

FIG. 2 illustrates an example environment 200 that includes a search engine 210. The search engine 210 is capable of providing search services, e.g., selecting one or more resources in response to receiving a search query and providing search results for the one or more resources. This environment 200 is provided as one example in which session data is collected for use in training a neural network by the training system 100 of FIG. 1.

A computer network 202, such as a local area network (LAN), wide area network (WAN), the Internet, or a combination thereof, connects publisher websites 204, user devices 206, and the search engine 210. The environment 200 may include many thousands of publisher websites 204 and user devices 206.

A publisher website 204 includes one or more resources 205 associated with a domain and hosted by one or more servers in one or more locations. Generally, a website is a collection of web pages formatted in hypertext markup language (HTML) that can contain text, images, multimedia content, and programming elements, for example, scripts. Each publisher website 204 is maintained by a content publisher, which is an entity that controls, manages and/or owns the publisher website 204.

A resource is any data that can be provided over the network 202 and that has a resource address, e.g., a uniform resource locator (URL). The resources 105 may be HTML pages, electronic documents, images files, video files, audio files, and feed sources, to name just a few. The resources may include embedded information, e.g., meta information and hyperlinks, and/or embedded instructions, e.g., client-side scripts.

A user device 206 is capable of requesting and receiving resources over the network 202. Example user devices 206 include personal computers, gaming devices, mobile communication devices, digital assistant devices, augmented reality devices, virtual reality devices, and other devices that can send and receive data over the network 202. A user device 206 typically includes a user application, e.g., a web browser, to facilitate the sending and receiving of data over the network 202. The web browser can enable a user to display and interact with text, images, videos, audio, music and other information typically located on a web page at a website on the World Wide Web or a local area network.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

To facilitate searching of these resources 205, the search engine 210 identifies the resources by crawling the publisher websites 204 and indexing the resources 205 provided by the publisher websites 204. The resources 205 are indexed and the index data are stored in a resource index.

The user devices 206 submit search queries 209 to the search engine 210. The search queries 209 may be in a form of a text query, a voice query, e.g., through a microphone in the user devices 206, a picture query, a video query, or the like. The search queries 209 are submitted in the form of a search request that includes the search request and, optionally, a unique identifier that identifies the user device 206 that submits the request. The unique identifier can be data from a cookie stored at the user device, or a user account identifier if the user maintains an account with the search engine 210, or some other identifier that identifies the user device 206 or the user using the user device.

In response to the search queries 209, the search engine 210 uses the resource index to identify resources that are relevant to the queries. The search engine 212 identifies the resources in the form of search results 211 and returns the search results 211 to the user devices 206, e.g., in a search results page resource. A search result 211 is data generated by the search engine 210 that identifies a resource or provides information that satisfies a particular search query. A search result 211 for a resource can include a web page title, a snippet of text extracted from the web page, and a resource locator for the resource, e.g., the URL of a web page.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device 206 according to the order.

The user devices 206 can receive the search results 211, e.g., in a search results web page, and render the search results for presentation to users. In response to the user selecting a search result at a user device 206, the user device 206 requests the resource 205 identified by the resource locator included in the selected search result. The publisher of the publisher website 204 hosting the resource 205 receives the request for the resource from the user device 206 and provides the resource 205 to the requesting user device 206.

The search engine 210 includes or has access to a session data repository 220 for storing session data for user sessions with the search engine 210. Each user session can include one or more queries. The session data for each session can include the one or more search queries, one or more search results provided to the user device 206 responsive to the queries, one or more actions performed by a user responsive to the search results, and, in some cases, metadata associated with the search queries and/or the search results.

The actions can include viewing the search results and/or interacting with the search results. For example, the session data can indicate the search results (e.g., the resource referenced by the search result) that were viewed (e.g., that appeared in a visible viewport on screen as some may be below the fold and not visible unless the user scrolls down) after being provided in response to a query and, if the user selects any search results, the search results selected by the user.

In some implementations, a user session is defined using a period of time, e.g., 10 minutes, 30 minutes, or 60 minutes, for sequential search queries. The search engine 210 determines whether the sequential search queries are received within the time period. A length of a user session may depend on the period of time for receiving associated sequential search queries in the user session. Suppose that the specific period of time is 30 minutes. In that case, a user session may have a longer time length, e.g., 120 minutes, 150 minutes, or longer, up to a maximum session time length, or may alternatively have a shorter time length, e.g., 30 minutes.

In some implementations, a user session is defined by a start event and an end event. The start event can be the user navigating to a search page, receipt of a first query from the user device 206 of the user, or another appropriate start event. The end event can be the end of a defined period of time after the start event, the end of a defined period of time since a last query was received from the user device 206 of the user without receiving another query from the user device 206 of the user, the user navigating away from the search page (e.g., for at least a defined period of time), or another appropriate end event.

User sessions for other types of content platforms can be defined similarly. For example, user session with a video sharing platform can include specific periods of time or start events (e.g., first video requested) and end events (e.g., closing of the video sharing application or web page or period of time since last video watched).

The session data for each user session can be stored in the session data repository 220 using any suitable data structure that includes the search queries, search results, and one or more actions, and possibly other pieces of information, organized by the relationships between them. For example, the session data can be stored using database, index, list, linked list, table, or any combination thereof.

As illustrated in FIG. 2, respective session data for user sessions 1-N is stored in the session data repository 220. For the first user session 221, the session data includes one or more search queries 223 submitted from a user device 106 to the search engine 210. The session data also includes one or more historical search results 225 provided by the search engine 210 responsive to the search queries 223. The session data also includes one or more user actions 227 taken by the user device 206 responsive to the search results 225 provided by the search engine 210. The user actions 227 are actions that were taken by the user device 206 (e.g., initiated by the user of the user device 206) the search results 225 were presented at the user device 206. For example, a user action 227 can be a selection of a particular search result that was presented in response to the search queries, e.g., a selection of a particular web page referenced by the search results. As another example, a user action 227 can be a browse, copy, or print action performed on a particular resource that was identified in response to the search queries 223.

Optionally, the session data further includes contextual data associated with the user session. The contextual data can be related to an environment in which the session occurred. For example, the contextual data can include the geographic region of the user device 106. A user's geographic region can be generalized where location information is obtained (such as to a city, ZIP code, or state level), so that a particular location of a user cannot be determined. As another example, the contextual data can include the timestamp at which a search query, e.g., the first search query that initiated the user session, was received by the search engine 210 from the user device 106.

In some cases, each user session is assigned a unique identifier representing the user session, e.g., a number identifier, a letter identifier, a combination thereof, or the like. The session identifier is different from, e.g., a user identifier, device identifier, or another personal identifier, such that no personally identifiable information can be determined based on the session data for the user session identified by the session identifier. For example, the session identifier for each user session can be generated by the search engine 210 using a random or pseudorandom process, or by assigning the identifiers in a sequence in which the user sessions occur. The search engine 210 associates respective session identifiers with respective session data of user sessions stored in the session data repository 220. Therefore, session data of a particular user session can be retrieved by determining a particular session identifier for the particular user session and using the particular session identifier to find the particular session data stored in the session data repository 220.

The session data stored in the session data repository 220, however, may have a raw format, such as one that is defined by the data structure in which it is stored, and thus may not be readily adapted to be processed by the language model neural network.

Referring back to FIG. 1, the training system 100 can include a training data generation engine 120 that is configured to convert the session data 110 into multiple training sequences 122. Each training sequence 122 includes data that represents multiple actions taken by a user and a system. For example, a training sequence can include user actions, followed by system actions taken in response to the user actions, followed by user actions performed in response to the system actions. In a search engine example, a training sequence can include one or more search queries, search results provided in response to each search query, and user actions taken in response to the search results for a corresponding user session. In a digital component example, a training sequence can include one or more actions that initiate a request for a digital component (e.g., navigating to a resource with a digital component slot), digital components provided in response to the requests, and actions by the user in response to the digital components (e.g., which digital component(s), if any, the user selected).

Each training sequence 122 has a suitable format that naturally fits into the configuration of language model neural networks. Typically, language model neural networks are pre-trained on text sequences. By converting the session data from its raw format into a format that is similar to language model pre-training data and then training the language model on the formatted session data, the pre-trained language model can be adapted to the one or more downstream task more quickly and with reduced computational resource consumption because it can more practically leverage what it has learned from the pre-training.

Although the training sequences and techniques for training neural networks that follow are largely described in terms of search engine sequences, the training sequences can include actions for other types of content, e.g., digital components, images, videos, and so on. In addition, the training sequences to train a neural network can include training sequences for multiple types of content, e.g., for search results and digital components.

In some implementations, the training data generation engine 120 can generate one training sequence 122 from the session data for each user session 112, while in some implementations, the training data generation engine 120 can generate two or more training sequences 122 from the session data for each user session 112, e.g., by truncating the session data into multiple different segments. For example, each training sequence can include a single query, the search results provided in response to the query, and the user actions performed in response to the search results. If a user session includes multiple queries, the training data generation engine 120 can generate a training sequence for each query rather than a training sequence for multiple queries.

In some implementations, each training sequence 122 includes one or more subsequence blocks that are arranged one after another in a predetermined order, e.g., includes a first subsequence block, followed by a second subsequence block, followed by a third subsequence block, and so on. In a search engine example, each subsequence block can be for an individual search query.

For example, each subsequence block can include multiple subsequences: (i) a search query subsequence that represents a search query submitted by a user to the search engine, (ii) a search result subsequence that represents one or more resources identified by the search engine based on the search query, (iii) a user action subsequence that represents one or more actions performed by the user in response to the one or more identified resources. Within each subsequence block, the multiple subsequences can be arranged in a predetermined order in which the search query subsequence is followed by the search result subsequence that is further followed by the user action subsequence. In other examples, however, the multiple subsequences can be arranged in a different order.

Each training sequence 122 can be limited to one or more subsequences rather than an entire user session. For example, a training sequence 122 can be limited to a predetermined number of subsequence blocks or a specific amount of time during the user session. In a particular example, a training sequence 122 can be limited to a particular number of search queries, resource views (e.g., to a particular number of distinct web pages, videos, or images viewed during a session), a particular number of domains views, a particular number of digital components viewed during a user session. Similarly, each subsequence block can be limited to a portion of a user session, e.g., to one or more search queries, one resource or digital component views, etc. As described herein, limiting subsequences to portions of sessions can improve the efficiency in training the model and the efficiency of the model itself, as well as enhance user privacy by preventing correlations between subsequences being used to track individual users across sites via outputs of the trained model.

In some implementations, each subsequence block also includes a metadata subsequence that represents metadata, e.g., contextual data, associated with a user session. The metadata subsequence, when included, can be arranged in any position within the subsequence block, e.g., preceding to the search query subsequence, subsequent to the user action subsequence, or another position in between.

Each subsequence includes a respective token selected from a vocabulary of tokens at each of multiple positions. The vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text.

As a particular example, the training sequence can have the following format:

$$J = M Q 1 R 1 \_ 1 R1\_ 2 … R1\_n I1\_ 1 I1\_ 2 … I1\_m Q 2 R2\_ 1 R2\_ 2 … ,$$

where M represents the metadata subsequence that represents metadata associated with a user session, Qi represents the i^{th} query subsequence that represents a search query, Ri_j represents the j^{th} resources identified by the search engine responsive to the search query represented by the i^{th} query, Ii_j represents the j^{th} action performed by the user after being presented with the search results of the search query represented by the i^{th} query.

To represent the metadata associated with a user session, the metadata subsequence M can include tokens that represent one or more of: a geographic region of the user device that submitted the queries during the user session, a unique identifier for the session (which may not be linked to the user or enable the user to be identified in any way), or a user application installed on the user device, or the like. The metadata subsequence can have the following format:

<Metadata> <Location> Mebane, Melville, Alamance County, North Carolina, United
States </Location> </Metadata>

In this example, the metadata subsequence is encapsulated by a set of predetermined tokens that precede and succeed the metadata associated with the user session, i.e., “<Metadata><Location>” and “</Location></Metadata>”.

To represent the search query submitted by a user to the search engine, the search query subsequence Q can have the following format:

<Query> <Query Timestamp> 2114 </Query Timestamp> <Query String> beach report
Outer Banks </Query String> </Query>

Like the metadata subsequence M, the search query subsequence Q is encapsulated by a set of predetermined tokens that precede and succeed the search query, i.e., “<Query>” and “</Query>”. In addition, the search query “beach report Outer Banks” is encapsulated by a set of predetermined tokens that precede and succeed the search query, i.e., “<Query String>” and “</Query String>”. Optionally, the search query subsequence also includes timestamp information, e.g., a current timestamp at which the search query was submitted by the user to the search engine, or a relative timestamp (the current timestamp relative to user session start timestamp). The timestamp information is encapsulated by a set of predetermined tokens that precede and succeed the timestamp information, i.e., “<Query Timestamp>” and “</Query Timestamp>”.

To represent the resources identified by the search engine based on the search query, the search result subsequence R can include tokens that represent one or more of: a resource address of the identified resource (e.g., a URL of a web page), a title of the identified resource (e.g., a web page title of the web page title), a brief description of the identified resource (e.g., a snippet of text extracted from the web page), or the like.

As one example, the search result subsequence R can have the following format:

```
    <Search Result> <Position> 1 </Position> <Type> doc </Type> <Title> North
      <b>Carolina</b>Beach<b>Report</b> News
  </Title><Url>https://www.example.com/NCBeachReports </Url> <Snippet> In most
    cases, the associated rotations vastly exceed those permissible by modern design
standards, rendering the <b>structure</b> unfit for purpose&nbsp;... </Snippet> </Search
        Result>
```

The search result subsequence R is encapsulated by a set of predetermined tokens that precede and succeed the search result, i.e., “<Search Result>” and “</Search Result>”. The web page title of an identified web page is encapsulated by a set of predetermined tokens that precede and succeed the web page title, i.e., “<Title>” and “</Title>”. The URL of the identified web page is encapsulated by a set of predetermined tokens that precede and succeed the URL, i.e., “<URL>” and “</URL>”. The brief description of the identified web page is encapsulated by a set of predetermined tokens that precede and succeed the brief description, i.e., “<Snippet>” and “</Snippet>”.

As another example, the search result subsequence R can have the following format:

```
    <Search Result> <Position> 0 </Position> <Type> WA </Type> <Title>
  Every<b>Original</b> Movie Character Returning For <b>Movie A </Title>
    <Url>https://example.com/movieA-sequel-returning-characters-original/
</Url><Answer> <b>Joe</b> as Mr. Smith<br><br> Instead of writing Mr. Smith out of
Movie A like the sequel does for Mrs. Baker, the decision was made to recast Bob's dad
      with Joe taking over the role. </Answer> </Search Result>
```

As yet another example, the search result subsequence R can have the following format:

<Search Result> <Position> 2 </Position> <Type> A </Type> <Question></Question>
how do i check my balance on my gift card? </Search Result>

To represent the actions performed by the user in response to the identified resources, the user action subsequence I can include tokens that represent one or more of: a selection of one of the identified resources by a user (e.g., a click on a URL of a web page), a browse of one of the identified resources by a user (e.g., a browse of the web page), a copy or print action of the identified resources by a user, or the like.

As one example, the user action subsequence I can have the following format:

```
    <Interaction> <Type> click </Type> <Click Timestamp> 2643 </Click Timestamp>
  <Title> The 50 <b>Best Movies</b> on <b>Streaming Service</b> (November 2022) -
  Magazine </Title> <Url> https://www.example.com/movies/best-movies-on-Streaming
    Service </Url> <Doc Content> The 50 best movies on Streaming Service (february
    2023); By Movies Staff | February 10, 2023 | 10:13am; Photo courtesy of Streaming
    Service Movies Lists Streaming Service; The 50 Best Movies on Streaming Service
(February 2023); The best movies on Streaming Service can be hard to find, but we're not
    likely to run out of great films any time soon. There's plenty to choose from, whether
  you're looking for the best action movies, the best horror films, the best comedies or the
    best classic movies on Streaming Service. We've updated the list for 2023 to remove
  great films that have left while highlighting underseen excellence. Rather than spending
    your time scrolling through categories, trying to track down the perfect film to watch,
    we've done our best to make it easy for you at Paste by updating our Best Movies to
    watch on Streaming Service list each week with new additions and overlooked films
    alike.; Here are the 50 best movies streaming on Streaming Service right now:; </Doc
      Content> </Interaction>
```

The user action subsequence I is encapsulated by a set of predetermined tokens that precede and succeed the user action, i.e., “<Interaction>” and “</Interaction>”. The user action subsequence I defines the type of action performed by the user as a click action and includes the timestamp associated with the click action. Moreover, the user action subsequence I defines what is being clicked, i.e., includes the URL of the identified web page that is being clicked upon. Like the other subsequences, these definitions are each encapsulated by a respective set of predetermined tokens, e.g., “<Type>” and “</Type>”.

As another example, the user action subsequence I can have the following format:

```
  <Interaction> <Type> click </Type> <Click Timestamp> 2643 </Click Timestamp>
    <Question> how do i check my balance on my gift card? </Question> <Url>
https://www.example.com/support/gift-card-faqs/ </Url> <Answer> You can check your
  gift card balance <b>online or by calling #GIFT (#4438) from your mobile phone or by
      calling (800) 000-0000</b>. </Answer> </Interaction>
```

As yet another example, the user action subsequence I can have the following format:

```
      <Interaction> <Type> long view </Type> <View Timestamp> 2643 </View
  Timestamp><Title> Every <b>Original</b> Movie Character Returning For <b>Movie
    A </Title> <Url> https://example.com/MovieA-sequel-returning-characters-original/
</Url> <Answer> <b>Joe</b> as Mr. Smith<br><br> Instead of writing Mr. Smith out of
  Movie A like the sequel does for Mrs. Baker, the decision was made to recast Bob's dad
        with Joe taking over the role. </Answer> </Interaction>
```

Because the session data may include information related to the specific search queries submitted by the users, the locations of the users, and so on, to ensure that the privacy of the users are preserved, e.g., to ensure that information related to a given user is not recoverable from the outputs that will be generated by the trained neural network, the system can remove sensitive user data before training the neural network, use anonymized identifiers for the sessions (as described above), and/or use k-anonymity techniques to ensure that user actions cannot be associated with a give user, as described above.

The k-anonymity techniques can include removing certain data from the sequences used to train the neural network. For example, if the training sequences 122 do not include data that shows that a sufficient number of users have viewed a resource or digital component or performed a particular action (e.g., submitted a search query or viewed a search result or other content), the data for the resource, digital component, or action can be removed from the training sequences 122 prior to training. This can prevent entities from microtargeting individual users to learn about the users from outputs of the trained neural network. For example, if only one user was shown a search result, the entity that provided the search result may be able to use the neural network to learn more about that user if the data for the search result is included in the trained sequences 122.

After using the training data generation engine 120 to generate the training sequences 122, the training system 100 then proceeds to train the language model neural network 130 on the training sequences 122. The training system 100 typically uses an iterative training process to determine trained values of the parameters of the language model neural network 130.

At each iteration of the training process, the training system 100 obtains a batch of one or more training sequences 122, e.g., either directly from the training data generation engine 120, or from a buffer in which these training sequences have been stored, and processes the batch using the language model neural network 130 in accordance with the current values of the parameters to generate a training output for each training sequence in the batch. The training system 100 determines, through backpropagation, the gradients of one of a set of pre-training objective functions that measure the quality of the training output, with respect to the parameters of the language model neural network 130. At the end of each iteration, the training system 100 applies respective updates to the current values of the parameters of the language model neural network 130 using the gradients determined at the iteration. This can be done by applying an appropriate optimizer, e.g., a stochastic gradient descent, RMSprop, or Adam optimizer, to the gradients.

In some implementations, after the language model neural network 130 has been trained on the training sequences 122 generated from session data 110, the training system 100 outputs data specifying the trained language model neural network 130. For example, the training system 100 can provide data specifying at least a portion of the trained values of the parameters, and, optionally, data specifying the architecture of the neural network, to a user that initiated the training process.

Instead of, or in addition to, outputting trained neural network data, the training system 100, or another system, can continue the training of the language model neural network 130 based on optimizing a different set of adaptation objective functions. The continued training will begin from the trained parameter values that have already been determined as a result of optimizing the set of pre-training objective functions.

Put another way, in some implementations, the training system 100 and, optionally, together with a separate training system, trains the language model neural network 130 using a two-stage training process: a pre-training stage, during which the system trains the neural network based on optimizing the set of pre-training objective functions, followed by an adaptation stage, during which the pre-trained neural network is adapted, e.g., fine-tuned or few-shot learned, to a downstream task based on optimizing a different adaptation objective function that is specific to the downstream task. For example, the downstream task can be any one of the machine learning tasks mentioned above.

Usually, the adaptation stage will use a relatively smaller amount of adaptation data than the total number of the training sequences 122. For example, the adaptation data can include a subset of the training sequences 122. As another example, the adaptation data can a set of labeled training examples that are specific to a particular downstream task. Each labeled training example can include a training input and, for each training input, a respective target output that should be generated by the neural network to perform the particular downstream task.

In some implementations, the training system 100, or another system, e.g., an inference system, can deploy the trained language model neural network 130 and then use the trained neural network to process requests received from users, e.g., through the API provided by the system. For example, an artificial intelligence (AI) system, e.g., an AI system deployed within the environment 200 that includes the search engine 210, can use the trained language model neural network 130 to perform the downstream task on new inputs to generate new outputs for the new inputs. In this example, the trained language model neural network 130 can be used to improve the quality of the search results that can be provided by the search engine 210, e.g., the relevancy or comprehensiveness of the search results with respect to the search query, or facilitate additional search services, such as conversational search services, or both. Moreover, the trained language model neural network 130 can be used to present resources, digital components, or other content items in a way that does not have negative long-term consequences on the user's future engagement with subsequent resources, e.g., to lower the likelihood that a user session is terminated or otherwise abandoned early. This will help improve the user experience and maintain long-term user engagement.

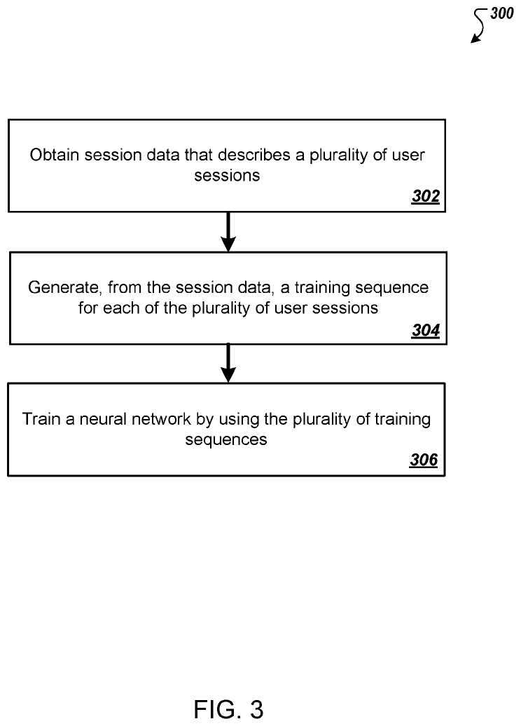

FIG. 3 is a flow diagram of an example process 300 for training a neural network using multiple training sequences. For convenience, the process 300 will be described as being performed by a system of one or more computers located in one or more locations. For example, a machine learning training system, e.g., the training system 100 of FIG. 1, appropriately programmed in accordance with this specification, can perform the process 300. The operations of the process 300 can also be implemented as instructions stored on a computer readable medium, which can be non-transitory. Execution of the instructions, by one or more data processing apparatus, causes the one or more data processing apparatus to perform operations of the process 300.

Although the process 300 is described in terms of user sessions with a search engine, other types of training sequences that include data for user sessions with other types of content systems (e.g., video sharing sites, websites, native applications, etc.) can be used to train the neural network, as described herein.

The system obtains session data that describes multiple user sessions (step 302). Each user session represents a corresponding interaction between a user and a search engine that occurs during a period of time. The system can obtain the session data from a session data repository for storing contextual data of user sessions. Each user session can include one or more search queries. The contextual data for each user session can include the one or more search queries, one or more search results responsive to the queries, one or more actions performed by a user responsive to the search results, and, in some cases, metadata associated with the search queries and/or the search results.

The system generates, from the session data, a training sequence for each of the multiple user sessions (step 304). The training sequence includes multiple subsequence blocks. In this example, each subsequence block includes (i) a search query subsequence that represents a search query submitted by the user to the search engine, (ii) a search result subsequence that represents one or more resources identified by the search engine based on the search query, and (iii) a user action subsequence that represents one or more actions performed by the user in response to the one or more identified resources. Within each training sequence, the multiple subsequence blocks are arranged one after another in a predetermined order. For example, the predetermined order can be a temporal order in which the search queries represented by the subsequence blocks were submitted by the user to the search engine.

For other types of content, a subsequence can include other formats. For example, a subsequence block can include (i) a request for a resource, (ii), a resource presented in response to the request, (iii) user interaction(s) with the resource. Optionally, such a subsequence block can also include (iv) digital component(s) presented with the resource and (v) data describing user interaction or non-interaction with each digital component. Such digital component data can also be used with the search subsequence blocks described above. This can be used to train the neural network to recommend resources to users and/or select digital components for presentation with resources.

An example subsequence block for digital components can include (i) digital component(s) presented to a user, (ii) data describing user interaction or non-interaction with each digital component, and optionally (iii) whether a specified action was performed by the user after presentation of and/or user interaction with the digital component. This can be used to train the neural network to generate a score for a digital component for a user, which can then be used to select a digital component for the user.

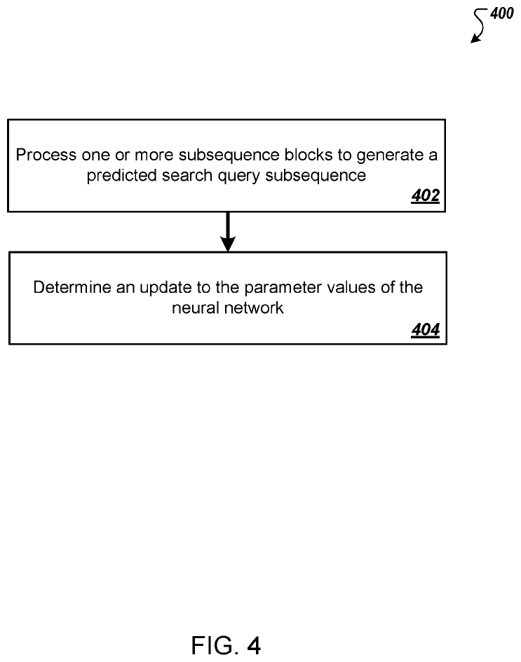

The system trains a neural network including learning parameter values of the neural network by using the plurality of training sequences based on optimizing a pre-training objective function (step 306). For example, the neural network can be a language model neural network, e.g., a Transformer-based language model neural network or a recurrent neural network-based language model. To train the neural network, the system can use any of a variety of pre-training objective functions. Training the neural network using an example of a pre-training objective function is explained in more detail with reference to FIG. 4, which shows sub-steps 402-404 corresponding to step 306.

FIG. 4 is a flow diagram of sub-steps of one of the steps of the process of FIG. 3. The system can obtain a batch of one or more training sequences and then repeatedly perform one iteration of steps 402 and 404 on each training sequence included in the batch.

The system processes, using the neural network, one or more subsequence blocks that precede a particular subsequence block of the training sequence to generate a predicted search query subsequence that is a prediction of a search query subsequence included in the particular subsequence block (step 402). That is, the neural network is configured to make search query refinement predictions, namely, given one or more previous search queries and their corresponding search results and actions performed by a user in response to the search results, the neural network is configured to predict the next search query that might be submitted by the user.

For example, assuming that the obtained batch includes a training sequence J=M Q1 R1 I1 Q2 R2 I2 Q3 R3 I3, the system can provide a truncated version of the training sequence, J′=M Q1 R1 I1 Q2 R2 I2, for processing by the neural network to generate a prediction of what follows J′ in the original training sequence J, i.e., a predicted Q3.

The system determines, based on computing a pre-training objective function that evaluates a difference between (i) the predicted search query subsequence and (ii) the search query subsequence included in the particular subsequence block, an update to the parameter values of the neural network (step 404). For example, the pre-training objective function can be a cross-entropy loss function.

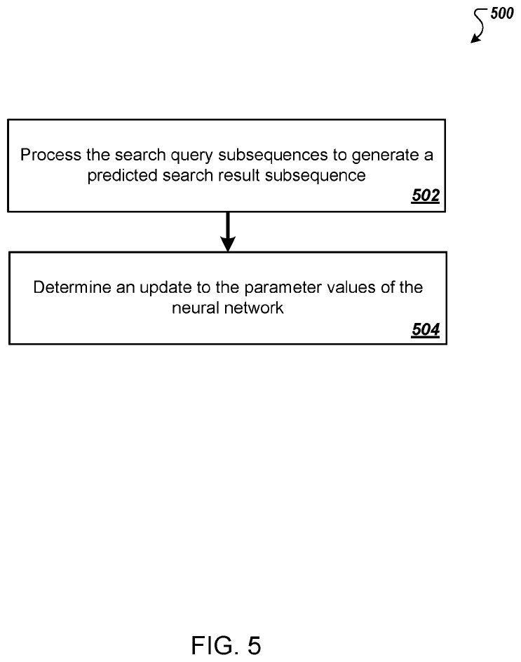

Training the neural network using another example of a pre-training objective function is explained in more detail with reference to FIG. 5, which shows sub-steps 502-504 corresponding to step 306.

FIG. 5 illustrates another flow diagram of sub-steps of one of the steps of the process of FIG. 3. Like the flow diagram of FIG. 4, the system can obtain a batch of one or more training sequences and then repeatedly perform one iteration of steps 502 and 504 on each training sequence included in the batch.

The system processes, using the neural network, the search query subsequences included in a particular subsequence block of the training sequence, and, optionally, the search query subsequences included in one or more subsequence blocks that precede the particular subsequence block to generate a predicted search result subsequence that is a prediction of a search result subsequence included in the particular subsequence block (step 502). That is, the neural network is configured to make search result predictions, namely, given a search query and, optionally, one or more previous search queries, the neural network is configured to predict the resources that might be identified by the search engine based on the search query. In another example, the neural network can be configured to predict the intent of the user, e.g., the informational needs of the user, give one or more queries.

For example, assuming that the obtained batch includes a training sequence J=M Q1 R1 I1 Q2 R2 I2, the system can provide an extracted portion of the training sequence, J′=Q1 Q2, for processing by the neural network to generate a prediction of what follows Q2 in the original training sequence J, i.e., a predicted R2.

The system determines, based on computing a pre-training objective function that evaluates a difference between the predicted search result subsequence and the search result subsequence included in the particular subsequence block, an update to the parameter values of the neural network (step 504). For example, the pre-training objective function can be a cross-entropy loss function.

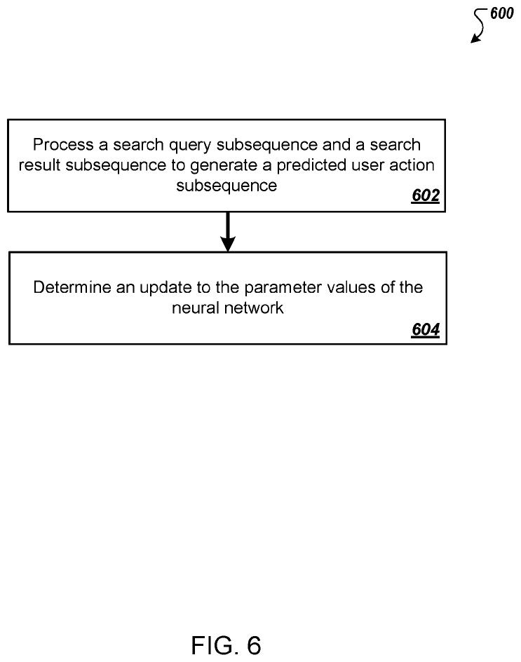

Training the neural network using yet another example of a pre-training objective function is explained in more detail with reference to FIG. 6, which shows sub-steps 602-604 corresponding to step 306.

FIG. 6 illustrates yet another flow diagram of sub-steps of one of the steps of the process of FIG. 3. Like the flow diagram of FIG. 4, the system can obtain a batch of one or more training sequences and then repeatedly perform one iteration of steps 402 and 404 on each training sequence included in the batch.

The system processes, using the neural network, a search query subsequence and a search result subsequence included in a particular subsequence block of the training sequence, and, optionally, one or more previous search query subsequences to generate a predicted user action subsequence that is a prediction of a user action subsequence included in the particular subsequence block (step 602). That is, the neural network is configured to make user action predictions, namely, given a search query and its corresponding search results, and, optionally, one or more previous search queries, the neural network is configured to predict the actions that might be performed by a user in response to the search results.

For example, assuming that the obtained batch includes a training sequence J=M Q1 R1 I1 Q2 R2 I2 Q3 R3 I3, the system can provide an extracted version of the training sequence, J′=Q1 Q2 R2, for processing by the neural network to generate a prediction of what follows R2 in the original training sequence J, i.e., a predicted I2.

The system determines, based on computing a pre-training objective function that evaluates a difference between the predicted user action subsequence and the user action subsequence included in the particular subsequence block, an update to the parameter values of the neural network (step 604). For example, the pre-training objective function can be a cross-entropy loss function.

In any of the examples of FIGS. 4-6, after computing the pre-training objective function over all training sequences included in the batch, the system can determine the gradients of the objective function through backpropagation. The system can then apply the update by applying an optimizer to gradients, e.g., a stochastic gradient descent optimizer, an RMSprop optimizer, or an Adam optimizer.

By repeatedly performing the process 400, 500, 600, or some combination thereof on multiple training sequences that have been generated from session data, the system can update the parameter values of the neural network, until a training termination criterion is met, e.g., after a predetermined number of iterations of the process 400, 500, or 600 have been performed, to determine the pre-trained parameter values of the neural network.

During training, the system can incorporate any number of techniques to improve the speed, the effectiveness, or both of the training stages. For example, the system can perform the training using data parallelism, model parallelism, or both to improve the efficiency of the training. As another example, the system can use sub-feature dropout to reduce the amount of overlapping content in the training sequences. Sub-feature dropout refers to randomly and independently dropping out certain tokens included in a training sequence in accordance with predetermined dropout rates. Applying sub-feature dropout to a training sequence can involve replacing one or more text tokens included in the training sequence with mask tokens in accordance with a predetermined mask probability.

Moreover, the system can use teacher distillation to train a distilled neural network that is easier to deploy than the presently pre-trained neural network (the “teacher” neural network), e.g., because it requires less computation, memory, or both, to generate outputs at run time than the teacher neural network, which may be a large-scale neural network that has 500 million, 1 billion, 10 billion, or more parameters. After training a teacher neural network by using the plurality of training sequences, applying teacher distillation can involve generating a plurality of truncated training sequences that exclude the search query subsequences included in the plurality of training sequences, using the trained neural network to train the neural network based on knowledge distillation by using the plurality of truncated training sequences.

Furthermore, the system can then fine-tune the pre-trained parameter values of the neural network on task-specific training data to optimize an objective function, e.g., a supervised objective function, for a particular downstream task, thereby adapting the pre-trained neural network to the particular downstream task. For example, the downstream task can be a resource relevance estimation task, where the neural network is configured to estimate a measure of relevance of a resource, e.g., a web page, with respect to a search query. As another example, the downstream task can be a next search query prediction task, where the neural network is configured to process one or more search queries to predict a next search query that might be submitted by a user following the one or more search queries. As yet another example, the downstream task can be a resource identification task, where the neural network is configured to process a search query to generate resource addresses of resources, e.g., URLs of web pages, that are relevant to the search query. As another example, the downstream task can be to predict the intent of a user given one or more queries submitted by the user or one or more digital components interacted with by the user. As another example, the downstream task can be to predict a digital component that is most likely to be interacted with by the user given one or more queries submitted by the user or one or more digital components interacted with by the user.

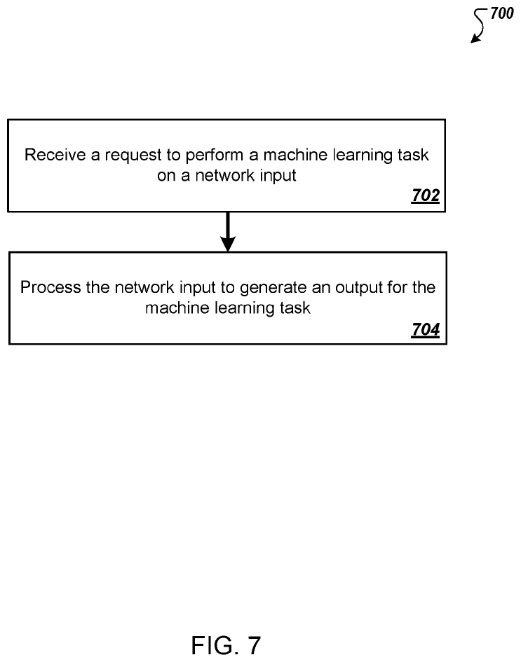

FIG. 7 illustrates an example process 700 for using a trained neural network to perform a machine learning task on an input to generate an output. For convenience, the process 700 will be described as being performed by a system of one or more computers located in one or more locations. For example, an artificial intelligence (AI) system, e.g., an artificial intelligence (AI) system that implements the language model neural network 130 of FIG. 1, appropriately programmed in accordance with this specification, can perform the process 700. The operations of the process 700 can also be implemented as instructions stored on a computer readable medium, which can be non-transitory. Execution of the instructions, by one or more data processing apparatus, causes the one or more data processing apparatus to perform operations of the process 700.

The system receives a request to perform a machine learning task on a network input (step 702). For example, the network input can include text data, image data, or both and possibly data in another modality, and can be received either as part of or in addition to the request for the machine learning task. The system can receive the network input in any of a variety of ways. For example, the system can receive the network input as an upload from a remote user of the system over a data communication network, e.g., using an application programming interface (API) made available by the system. As another example, the system can receive an input from a user specifying which data that is already maintained by the system should be used as the network input.

The network input can include data indicating one or more actions performed by a user. For example, the network input can include one or more search queries provided by the user, one or more resources (e.g., web pages, videos, text, etc.) requested by and/or presented to the user, digital components presented to the user and/or interacted with by the user. The network input can also include contextual data related to the actions.

In some implementations, the system includes a search engine. The search engine is capable of providing search services, i.e., selecting one or more resources in response to receiving a search query. Example resources include video files, image files, audio files, or Web pages, including content for particular subjects, book articles, or news articles, to name just a few examples.

In some implementations, the system includes a service apparatus. The service apparatus chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script) in response to receiving the component request and/or using information included in the component request.

The system processes, using a neural network that has been trained using the techniques described above with reference to FIGS. 3-6 and in accordance with the trained parameter values of the neural network, the network input to generate an output for the machine learning task (step 704). In general, the machine learning task can be any one of the tasks mentioned above, e.g., a resource relevance estimation task, a next search query prediction task, or a resource identification task, and the network output can be any kind of score, classification, or regression output based on the network input.

As a particular example, the machine learning task can be a digital component presentation task. In this example, the system receives data characterizing a current state of a presentation environment (which can include contextual data and/or data described actions of a user) and, in response, determines whether or not present the digital component to the user on the user device when the presentation environment is the current state or a score for the digital component. The scores for multiple digital components can then be used to select a digital component for presentation to the user, e.g., the digital component having the highest score.

For example, the digital components are candidates for presentation in a response to a search query, e.g., as part of a search results web page. That is, the presentation environment is a search query response, e.g., a search results web page, and different states of the presentation correspond to different instances of search query responses, i.e., presentations that are responses to different search queries submitted by various users. In this example, the digital components may be search results that are candidates for being included in the response or online advertisements that are candidates for being included in the response along with search results.

As another, the digital components are recommendations of content that may be of interest to a user that is currently being presented with a piece of content. That is, the presentation environment is a presentation of a piece of content to a user that includes recommendations of other pieces of content that may be of interest to the user. For example, the presentation environment may be a presentation of a video that includes one or more previews that each identify other videos, e.g., by including a thumbnail from the video and other identifying information for the video and including a link to the video, that may be of interest to the user. As another example, the presentation environment may be a presentation of an image that includes one or more previews that each identify other images, e.g., by including a thumbnail of the image and including a link to the image, that may be of interest to the user.

If the presentation subsystem determines to present the digital component in the presentation environment, the presentation system can transmit the digital component for presentation to the user or transmit an indication to a presentation environment system that causes the presentation environment system to provide the digital component for presentation the user in the presentation environment.

Alternatively, if the presentation system determines not to present the digital component, the presentation system refrains from transmitting the digital component for presentation to the user or transmits an indication to the presentation environment system that the digital component should not be presented to the user in the presentation environment.

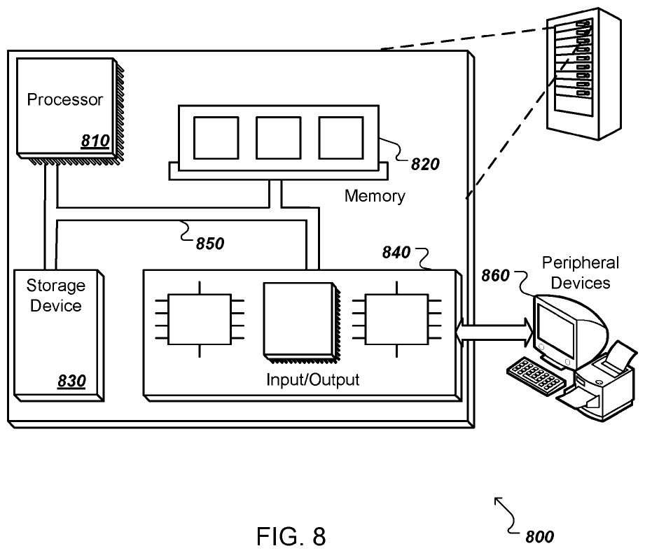

FIG. 8 is a block diagram of an example computer system 800 that can be used to perform operations described above. The system 800 includes a processor 810, a memory 820, a storage device 830, and an input/output device 840. Each of the components 810, 820, 830, and 840 can be interconnected, for example, using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can include, for example, a hard disk device, an optical disk device, a storage device that is shared over a network by multiple computing devices (e.g., a cloud storage device), or some other large capacity storage device.

The input/output device 840 provides input/output operations for the system 800. In one implementation, the input/output device 840 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 860. Other implementations, however, can also be used, such as mobile computing devices, mobile communication devices, set-top box television client devices, etc.

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
obtaining session data that describes a plurality of user sessions, each user session representing a corresponding interaction between a user and a search engine that occurs during a period of time;
generating, from the session data, a training sequence for each of the plurality of user sessions, the training sequence comprising a plurality of subsequence blocks arranged one after another in a predetermined order, each subsequence block comprising (i) a search query subsequence that represents a search query submitted by the user to the search engine, (ii) a search result subsequence that represents one or more resources identified by the search engine based on the search query, and (iii) a user action subsequence that represents one or more actions performed by the user in response to the one or more identified resources; and
training a neural network including learning parameter values of the neural network by using the plurality of training sequences based on optimizing a pre-training objective function.

2. The method of claim 1, further comprising fine-tuning the neural network for a given task using one-shot learning or few-shot learning.

3. The method of claim 1, wherein each subsequence comprises a respective text token at each of a plurality of input positions selected from a predetermined vocabulary of text tokens.

4. The method of claim 1, wherein the training sequence further comprises a metadata subsequence that represents metadata associated with the user session.

5. The method of claim 4, wherein the metadata associated with the user session comprises a geographic location of the user.

6. The method of claim 1, wherein the search query subsequence further comprises a timestamp indicating when the search query was received by the search engine from the user.

7. The method of claim 1, wherein the search result subsequence comprises, for each identified resource, one or more of:
a resource address of the identified resource, a title of the identified resource, or a brief description of the identified resource.

8. The method of claim 1, wherein the one or more actions performed by the user comprise:
a selection of one of the identified resources, a browse of one of the identified resources, or both by the user.

9. The method of claim 1, wherein the predetermined order is a temporal order in which the search queries represented by the subsequence blocks were received by search engine from the user.

10. The method of claim 1, wherein training the neural network by using the plurality of training sequences based on optimizing the pre-training objective function comprises, for each of one or more of the plurality of training sequences:
processing, using the neural network, one or more subsequence blocks that precede a particular subsequence block of the training sequence to generate a predicted search query subsequence that is a prediction of a search query subsequence included in the particular subsequence block; and
determining, based on a difference between the predicted search query subsequence and the search query subsequence included in the particular subsequence block, an update to the parameter values of the neural network.

11. The method of claim 1, wherein training the neural network by using the plurality of training sequences based on optimizing the pre-training objective function comprises, for each of one or more of the plurality of training sequences:
processing, using the neural network, the search query subsequences included in a particular subsequence block of the training sequence to generate a predicted search result subsequence that is a prediction of a search result subsequence included in the particular subsequence block; and
determining, based on a difference between the predicted search result subsequence and the search result subsequence included in the particular subsequence block, an update to the parameter values of the neural network.

12. The method of claim 1, wherein training the neural network by using the plurality of training sequences based on optimizing the pre-training objective function comprises, for each of one or more of the plurality of training sequences:
processing, using the neural network, a search query subsequence and a search result subsequence included in a particular subsequence block of the training sequence to generate a predicted user action subsequence that is a prediction of a user action subsequence included in the particular subsequence block; and
determining, based on a difference between the predicted user action subsequence and the user action subsequence included in the particular subsequence block, an update to the parameter values of the neural network.

13. The method of claim 1, wherein generating the training sequence for each of the plurality of user sessions comprises replacing one or more text tokens included in the training sequence with mask tokens in accordance with a predetermined mask probability.

14. The method of claim 1, further comprising:
after the training, adapting the trained neural network to perform a downstream task, wherein the downstream task comprises one of: a resource relevance estimation task, a next search query prediction task, or a resource identification task.

15. The method of claim 1, wherein training the neural network by using the plurality of training sequences based on optimizing the pre-training objective function comprises:
training a teacher neural network by using the plurality of training sequences;
generating a plurality of truncated training sequences that exclude the search query subsequences included in the plurality of training sequences; and
using the trained neural network to train the neural network based on knowledge distillation by using the plurality of truncated training sequences.

16. The method of claim 1, wherein the neural network is an attention neural network that comprises a plurality attention blocks.

17. The method of claim 1, wherein generating the training sequence for each of the plurality of user sessions comprises removing user identifying information from the session data.

18. The method of claim 1, wherein generating the training sequence for each of the plurality of user sessions comprises:
identifying a search query that has been received from fewer than a threshold number of users; and
removing, from the training sequence, each subsequence block that includes the search query.

19. The method of claim 1, wherein generating the training sequence for each of the plurality of user sessions comprises:
identifying a search result that has been provided to fewer than a threshold number of users; and
removing, from the training sequence, each subsequence block that includes the search result.

20. The method of claim 1, wherein generating the session data for each of the plurality of user sessions comprises limiting each subsequence block to a portion of the user session.

21. The method of claim 1, wherein generating the training sequence for each of the plurality of user sessions comprises limiting the training sequence for each user session to a threshold number of subsequence blocks.

22. (canceled)

23. A system comprising one or more computers and one or more storage devices storing instructions that when executed by the one or more computers cause the one more computers to perform operations comprising:
obtaining session data that describes a plurality of user sessions, each user session representing a corresponding interaction between a user and a search engine that occurs during a period of time;
generating, from the session data, a training sequence for each of the plurality of user sessions, the training sequence comprising a plurality of subsequence blocks arranged one after another in a predetermined order, each subsequence block comprising (i) a search query subsequence that represents a search query submitted by the user to the search engine, (ii) a search result subsequence that represents one or more resources identified by the search engine based on the search query, and (iii) a user action subsequence that represents one or more actions performed by the user in response to the one or more identified resources; and
training a neural network including learning parameter values of the neural network by using the plurality of training sequences based on optimizing a pre-training objective function.

24. One or more non-transitory computer storage media storing instructions that when executed by one or more computers cause the one more computers to perform operations of the respective method comprising:
obtaining session data that describes a plurality of user sessions, each user session representing a corresponding interaction between a user and a search engine that occurs during a period of time;
generating, from the session data, a training sequence for each of the plurality of user sessions, the training sequence comprising a plurality of subsequence blocks arranged one after another in a predetermined order, each subsequence block comprising (i) a search query subsequence that represents a search query submitted by the user to the search engine, (ii) a search result subsequence that represents one or more resources identified by the search engine based on the search query, and (iii) a user action subsequence that represents one or more actions performed by the user in response to the one or more identified resources; and
training a neural network including learning parameter values of the neural network by using the plurality of training sequences based on optimizing a pre-training objective function.

25. (canceled)
